(19) United States
(12) Patent Application Publication
(10) Pub. No.: US 2025/0111163 A1
(43) Pub. Date: Apr. 3, 2025

(54) Electronic Device That Displays Text Summaries

(71) Applicant: Apple Inc., Cupertino, CA (US)

(72) Inventors: Anna L Brewer, Santa Barbara, CA (US); Anshu K Chimalamarri, Sunnyvale, CA (US); Devin W Chalmers, Oakland, CA (US); Thomas G Salter, San Francisco, CA (US)

(21) Appl. No.: 18/798,640

(22) Filed: Aug. 8, 2024

Related U.S. Application Data
(60) Provisional application No. 63/586,281, filed on Sep. 28, 2023.
(60) Provisional application No. 63/598,688, filed on Nov. 14, 2023.
(60) Provisional application No. 63/550,969, filed on Feb. 7, 2024.

(51) Int. Cl. G06F 40/35; G06F 3/01; G06V 30/14

(52) U.S. Cl. CPC G06F 40/35; G06F 3/011; G06V 30/14

(57) ABSTRACT

A head-mounted device may include one or more cameras that detect text in a physical environment surrounding the head-mounted device. The head-mounted device may send information regarding the text in the physical environment, contextual information, response length parameters, and/or user questions associated with the text in the physical environment to a trained model. The trained model may be a large language model. The head-mounted device may receive a text summary from the trained model that is based on the information regarding the text, contextual information, response length parameters, and user questions. The head-mounted device may present the text summary on one or more displays.

This application claims the benefit of U.S. provisional patent application No. 63/586,281 filed Sep. 28, 2023, U.S. provisional patent application No. 63/598,688 filed Nov. 14, 2023, and U.S. provisional patent application No. 63/550,969 filed Feb. 7, 2024, which are hereby incorporated by reference herein in their entireties.

### BACKGROUND

This relates generally to head-mounted devices, and, more particularly, to head-mounted devices with displays.

Some electronic devices such as head-mounted devices include video passthrough or see-through displays. A user may view a physical environment that includes text through the video passthrough or see-through displays.

It is within this context that the embodiments herein arise.

### SUMMARY

An electronic device may include one or more cameras, one or more displays, one or more processors, and memory storing instructions configured to be executed by the one or more processors, the instructions for obtaining a user input, determining an intent based on the user input, and in accordance with a determination that the user intent represents an intent to provide a summary of text in a physical environment, providing information regarding the text to a trained model, the information regarding the text obtained from one or more images of the physical environment captured using the one or more cameras, and presenting a text summary from the trained model on the one more displays.

### BRIEF DESCRIPTION OF THE DRAWINGS

FIG. 1 is a schematic diagram of an illustrative head-mounted device in accordance with some embodiments.

FIG. 2 is a view of an illustrative physical environment that includes text and that is viewable through a display that presents a text summary associated with the text and adjacent to the text in accordance with some embodiments.

FIG. 3 is a view of an illustrative physical environment that includes text and that is viewable through a display that presents a text summary associated with the text and over the text in accordance with some embodiments.

FIG. 4 is a diagram of an illustrative system including a head-mounted device that sends information to a trained model and receives a text summary from the trained model in accordance with some embodiments.

FIG. 5 is a flowchart showing an illustrative method for operating an electronic device that presents text summaries from a trained model in accordance with some embodiments.

### DETAILED DESCRIPTION

Head-mounted devices may display different types of extended reality content for a user. The head-mounted device may display a virtual object that is perceived at an apparent depth within the physical environment of the user. Virtual objects may sometimes be displayed at fixed locations relative to the physical environment of the user. For example, consider an example where a user's physical environment includes a table. A virtual object may be displayed for the user such that the virtual object appears to be resting on the table. As the user moves their head and otherwise interacts with the XR environment, the virtual object remains at the same, fixed position on the table (e.g., as if the virtual object were another physical object in the XR environment). This type of content may be referred to as world-locked content (because the position of the virtual object is fixed relative to the physical environment of the user).

Other virtual objects may be displayed at locations that are defined relative to the head-mounted device or a user of the head-mounted device. First, consider the example of virtual objects that are displayed at locations that are defined relative to the head-mounted device. As the head-mounted device moves (e.g., with the rotation of the user's head), the virtual object remains in a fixed position relative to the head-mounted device. For example, the virtual object may be displayed in the front and center of the head-mounted device (e.g., in the center of the device's or user's field-of-view) at a particular distance. As the user moves their head left and right, their view of their physical environment changes accordingly. However, the virtual object may remain fixed in the center of the device's or user's field of view at the particular distance as the user moves their head (assuming gaze direction remains constant). This type of content may be referred to as head-locked content. The head-locked content is fixed in a given position relative to the head-mounted device (and therefore the user's head which is supporting the head-mounted device). The head-locked content may not be adjusted based on a user's gaze direction. In other words, if the user's head position remains constant and their gaze is directed away from the head-locked content, the head-locked content will remain in the same apparent position.

Second, consider the example of virtual objects that are displayed at locations that are defined relative to a portion of the user of the head-mounted device (e.g., relative to the user's torso). This type of content may be referred to as body-locked content. For example, a virtual object may be displayed in front and to the left of a user's body (e.g., at a location defined by a distance and an angular offset from a forward-facing direction of the user's torso), regardless of which direction the user's head is facing. If the user's body is facing a first direction, the virtual object will be displayed in front and to the left of the user's body. While facing the first direction, the virtual object may remain at the same, fixed position relative to the user's body in the XR environment despite the user rotating their head left and right (to look towards and away from the virtual object). However, the virtual object may move within the device's or user's field of view in response to the user rotating their head. If the user turns around and their body faces a second direction that is the opposite of the first direction, the virtual object will be repositioned within the XR environment such that it is still displayed in front and to the left of the user's body. While facing the second direction, the virtual object may remain at the same, fixed position relative to the user's body in the XR environment despite the user rotating their head left and right (to look towards and away from the virtual object).

In the aforementioned example, body-locked content is displayed at a fixed position/orientation relative to the user's body even as the user's body rotates. For example, the virtual object may be displayed at a fixed distance in front of the user's body. If the user is facing north, the virtual object is in front of the user's body (to the north) by the fixed distance. If the user rotates and is facing south, the virtual object is in front of the user's body (to the south) by the fixed distance.

Alternatively, the distance offset between the body-locked content and the user may be fixed relative to the user whereas the orientation of the body-locked content may remain fixed relative to the physical environment. For example, the virtual object may be displayed in front of the user's body at a fixed distance from the user as the user faces north. If the user rotates and is facing south, the virtual object remains to the north of the user's body at the fixed distance from the user's body.

Body-locked content may also be configured to always remain gravity or horizon aligned, such that head and/or body changes in the roll orientation would not cause the body-locked content to move within the XR environment. Translational movement may cause the body-locked content to be repositioned within the XR environment to maintain the fixed distance from the user. Subsequent descriptions of body-locked content may include both of the aforementioned types of body-locked content.

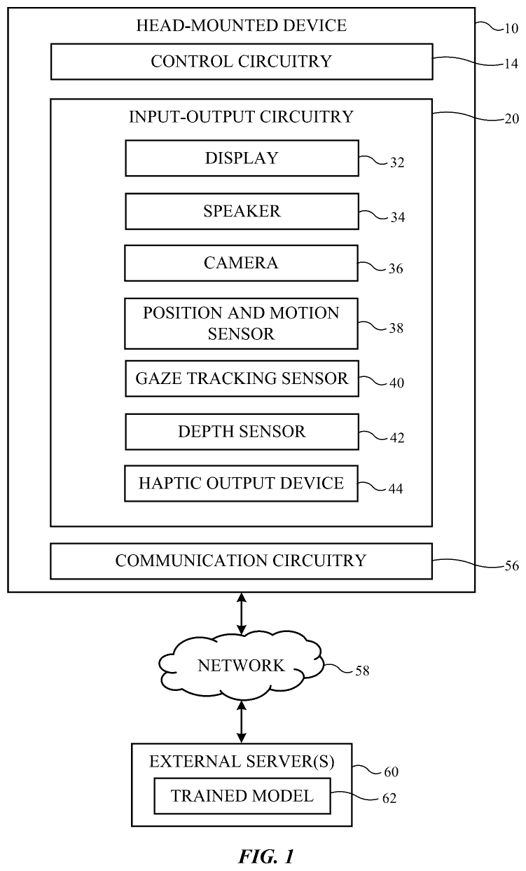

A schematic diagram of an illustrative head-mounted device is shown in FIG. 1. As shown in FIG. 1, head-mounted device 10 (sometimes referred to as electronic device 10, system 10, head-mounted display 10, etc.) may have control circuitry 14. Control circuitry 14 may be configured to perform operations in head-mounted device 10 using hardware (e.g., dedicated hardware or circuitry), firmware and/or software. Software code for performing operations in head-mounted device 10 and other data is stored on non-transitory computer readable storage media (e.g., tangible computer readable storage media) in control circuitry 14. The software code may sometimes be referred to as software, data, program instructions, instructions, or code. The non-transitory computer readable storage media (sometimes referred to generally as memory) may include non-volatile memory such as non-volatile random-access memory (NVRAM), one or more hard drives (e.g., magnetic drives or solid state drives), one or more removable flash drives or other removable media, or the like. Software stored on the non-transitory computer readable storage media may be executed on the processing circuitry of control circuitry 14. The processing circuitry may include application-specific integrated circuits with processing circuitry, one or more microprocessors, digital signal processors, graphics processing units, a central processing unit (CPU) or other processing circuitry.

Head-mounted device 10 may include input-output circuitry 20. Input-output circuitry 20 may be used to allow data to be received by head-mounted device 10 from external equipment (e.g., a tethered computer, a portable device such as a handheld device or laptop computer, or other electrical equipment) and to allow a user to provide head-mounted device 10 with user input. Input-output circuitry 20 may also be used to gather information on the environment in which head-mounted device 10 is operating. Output components in circuitry 20 may allow head-mounted device 10 to provide a user with output and may be used to communicate with external electrical equipment.

As shown in FIG. 1, input-output circuitry 20 may include a display such as display 32. Display 32 may be used to display images for a user of head-mounted device 10. Display 32 may be a transparent display (sometimes referred to as a see-through display) so that a user may observe physical objects through the display while computer-generated content is overlaid on top of the physical objects by presenting computer-generated images on the display. A transparent display may be formed from a transparent pixel array (e.g., a transparent organic light-emitting diode display panel) or may be formed by a display device that provides images to a user through a beam splitter, holographic coupler, or other optical coupler (e.g., a display device such as a liquid crystal on silicon display). Alternatively, display 32 may be an opaque display that blocks light from physical objects when a user operates head-mounted device 10. In this type of arrangement, a pass-through camera may be used to display physical objects to the user. The pass-through camera may capture images of the physical environment and the physical environment images may be displayed on the display for viewing by the user. Additional computer-generated content (e.g., text, game-content, other visual content, etc.) may optionally be overlaid over the physical environment images to provide an extended reality environment for the user. When display 32 is opaque, the display may also optionally display entirely computer-generated content (e.g., without displaying images of the physical environment).

Display 32 may include one or more optical systems (e.g., lenses) that allow a viewer to view images on display(s) 16. A single display 32 may produce images for both eyes or a pair of displays 16 may be used to display images. In configurations with multiple displays (e.g., left and right eye displays), the focal length and positions of the lenses may be selected so that any gap present between the displays will not be visible to a user (e.g., so that the images of the left and right displays overlap or merge seamlessly). Display modules that generate different images for the left and right eyes of the user may be referred to as stereoscopic displays. The stereoscopic displays may be capable of presenting two-dimensional content (e.g., a user notification with text) and three-dimensional content (e.g., a simulation of a physical object such as a cube).

Input-output circuitry 20 may include various other input-output devices for gathering data and user input and for supplying a user with output. For example, input-output circuitry 20 may include one or more speakers 34 that are configured to play audio.

Input-output circuitry 20 may include one or more cameras 36. Cameras 36 may include one or more outward-facing cameras (that face the physical environment around the user when the electronic device is mounted on the user's head, as one example). Cameras 36 may capture visible light images, infrared images, or images of any other desired type. The cameras may be stereo cameras if desired. Outward-facing cameras may capture pass-through video for device 10. Cameras 22 may also include inward-facing cameras (e.g., for gaze detection).

Input-output circuitry 20 may include a gaze-tracker 40 (sometimes referred to as a gaze-tracking system or a gaze-tracking camera). The gaze-tracker 40 may be used to obtain gaze input from the user during operation of head-mounted device 10.

Gaze-tracker 40 may include a camera and/or other gaze-tracking system components (e.g., light sources that emit beams of light so that reflections of the beams from a user's eyes may be detected) to monitor the user's eyes. Gaze-tracker(s) 40 may face a user's eyes and may track a user's gaze. A camera in the gaze-tracking system may determine the location of a user's eyes (e.g., the centers of the user's pupils), may determine the direction in which the user's eyes are oriented (the direction of the user's gaze), may determine the user's pupil size (e.g., so that light modulation and/or other optical parameters and/or the amount of gradualness with which one or more of these parameters is spatially adjusted and/or the area in which one or more of these optical parameters is adjusted is adjusted based on the pupil size), may be used in monitoring the current focus of the lenses in the user's eyes (e.g., whether the user is focusing in the near field or far field, which may be used to assess whether a user is day dreaming or is thinking strategically or tactically), and/or other gaze information. Cameras in the gaze-tracking system may sometimes be referred to as inward-facing cameras, gaze-detection cameras, eye-tracking cameras, gaze-tracking cameras, or eye-monitoring cameras. If desired, other types of image sensors (e.g., infrared and/or visible light-emitting diodes and light detectors, etc.) may also be used in monitoring a user's gaze. The use of a gaze-detection camera in gaze-tracker 40 is merely illustrative.

As shown in FIG. 1, input-output circuitry 20 may include position and motion sensors 38 (e.g., compasses, gyroscopes, accelerometers, and/or other devices for monitoring the location, orientation, and movement of head-mounted device 10, satellite navigation system circuitry such as Global Positioning System circuitry for monitoring user location, etc.). Gyroscopes may measure orientation and angular velocity of the electronic device. As one example, electronic device 10 may include a first gyroscope that is configured to measure rotation about a first axis, a second gyroscope that is configured to measure rotation about a second axis that is orthogonal to the first axis, and a third gyroscope that is configured to measure rotation about a third axis that is orthogonal to the first and second axes. An accelerometer may measure the acceleration felt by the electronic device. As one example, electronic device 10 may include a first accelerometer that is configured to measure acceleration along a first axis, a second accelerometer that is configured to measure acceleration along a second axis that is orthogonal to the first axis, and a third accelerometer that is configured to measure acceleration along a third axis that is orthogonal to the first and second axes. Multiple sensors may optionally be included in a single sensor package referred to as an inertial measurement unit (IMU). Electronic device 10 may include one or more magnetometers that are configured to measure magnetic field. As an example, three magnetometers may be included in an IMU with three accelerometers and three gyroscopes.

Using sensors 38, for example, control circuitry 14 can monitor the current direction in which a user's head is oriented relative to the surrounding environment (e.g., a user's head pose). In one example, position and motion sensors 38 may include one or more outward-facing cameras (e.g., that capture images of a physical environment surrounding the user). The outward-facing cameras may be used for face tracking (e.g., by capturing images of the user's jaw, mouth, etc. while the device is worn on the head of the user), body tracking (e.g., by capturing images of the user's torso, arms, hands, legs, etc. while the device is worn on the head of user), and/or for localization (e.g., using visual odometry, visual inertial odometry, or other simultaneous localization and mapping (SLAM) technique). In addition to being used for position and motion sensing, the outward-facing camera may capture pass-through video for device 10.

Input-output circuitry 20 may include one or more depth sensors 42. Each depth sensor may be a pixelated depth sensor (e.g., that is configured to measure multiple depths across the physical environment) or a point sensor (that is configured to measure a single depth in the physical environment). Camera images (e.g., from one of cameras 36) may also be used for monocular and/or stereo depth estimation. Each depth sensor (whether a pixelated depth sensor or a point sensor) may use phase detection (e.g., phase detection autofocus pixel(s)) or light detection and ranging (LIDAR) to measure depth. Any combination of depth sensors may be used to determine the depth of physical objects in the physical environment.

Input-output circuitry 20 may include a haptic output device 44. The haptic output device 44 may include actuators such as electromagnetic actuators, motors, piezoelectric actuators, electroactive polymer actuators, vibrators, linear actuators (e.g., linear resonant actuators), rotational actuators, actuators that bend bendable members, etc. The haptic output device 44 may be controlled to provide any desired pattern of vibrations.

Input-output circuitry 20 may also include other sensors and input-output components if desired (e.g., ambient light sensors, force sensors, temperature sensors, touch sensors, buttons, capacitive proximity sensors, light-based proximity sensors, other proximity sensors, strain gauges, gas sensors, pressure sensors, moisture sensors, magnetic sensors, microphones, light-emitting diodes, other light sources, wired and/or wireless communications circuitry, etc.).

Head-mounted device 10 may also include communication circuitry 56 to allow the head-mounted device to communicate with external equipment (e.g., a tethered computer, a portable electronic device, one or more external servers, or other electrical equipment). Communication circuitry 56 may be used for both wired and wireless communication with external equipment.

Communication circuitry 56 may include radio-frequency (RF) transceiver circuitry formed from one or more integrated circuits, power amplifier circuitry, low-noise input amplifiers, passive RF components, one or more antennas, transmission lines, and other circuitry for handling RF wireless signals. Wireless signals can also be sent using light (e.g., using infrared communications).

The radio-frequency transceiver circuitry in wireless communications circuitry 56 may handle wireless local area network (WLAN) communications bands such as the 2.4 GHz and 5 GHz Wi-Fi® (IEEE 802.11) bands, wireless personal area network (WPAN) communications bands such as the 2.4 GHz Bluetooth® communications band, cellular telephone communications bands such as a cellular low band (LB) (e.g., 600 to 960 MHz), a cellular low-midband (LMB) (e.g., 1400 to 1550 MHz), a cellular midband (MB) (e.g., from 1700 to 2200 MHz), a cellular high band (HB) (e.g., from 2300 to 2700 MHz), a cellular ultra-high band (UHB) (e.g., from 3300 to 5000 MHz, or other cellular communications bands between about 600 MHz and about 5000 MHz (e.g., 3G bands, 4G LTE bands, 5G New Radio Frequency Range 1 (FR1) bands below 10 GHz, etc.), a near-field communications (NFC) band (e.g., at 13.56 MHz), satellite navigations bands (e.g., an L1 global positioning system (GPS) band at 1575 MHz, an L5 GPS band at 1176 MHz, a Global Navigation Satellite System (GLONASS) band, a BeiDou Navigation Satellite System (BDS) band, etc.), ultra-wideband (UWB) communications band(s) supported by the IEEE 802.15.4 protocol and/or other UWB communications protocols (e.g., a first UWB communications band at 6.5 GHz and/or a second UWB communications band at 8.0 GHz), and/or any other desired communications bands.

The radio-frequency transceiver circuitry may include millimeter/centimeter wave transceiver circuitry that supports communications at frequencies between about 10 GHz and 300 GHz. For example, the millimeter/centimeter wave transceiver circuitry may support communications in Extremely High Frequency (EHF) or millimeter wave communications bands between about 30 GHz and 300 GHz and/or in centimeter wave communications bands between about 10 GHz and 30 GHz (sometimes referred to as Super High Frequency (SHF) bands). As examples, the millimeter/centimeter wave transceiver circuitry may support communications in an IEEE K communications band between about 18 GHz and 27 GHz, a Kₐ communications band between about 26.5 GHz and 40 GHz, a Kᵤ communications band between about 12 GHz and 18 GHz, a V communications band between about 40 GHz and 75 GHz, a W communications band between about 75 GHz and 110 GHz, or any other desired frequency band between approximately 10 GHz and 300 GHz. If desired, the millimeter/centimeter wave transceiver circuitry may support IEEE 802.11ad communications at 60 GHz (e.g., WiGig or 60 GHz Wi-Fi bands around 57-61 GHz), and/or 5^{th} generation mobile networks or 5^{th} generation wireless systems (5G) New Radio (NR) Frequency Range 2 (FR2) communications bands between about 24 GHz and 90 GHz.

Antennas in wireless communications circuitry 56 may include antennas with resonating elements that are formed from loop antenna structures, patch antenna structures, inverted-F antenna structures, slot antenna structures, planar inverted-F antenna structures, helical antenna structures, dipole antenna structures, monopole antenna structures, hybrids of these designs, etc. Different types of antennas may be used for different bands and combinations of bands. For example, one type of antenna may be used in forming a local wireless link and another type of antenna may be used in forming a remote wireless link antenna.

During operation, head-mounted device 10 may use communication circuitry 56 to communicate with one or more external servers 60 through network(s) 58. Examples of communication network(s) 58 include local area networks (LAN) and wide area networks (WAN) (e.g., the Internet). Communication network(s) 58 may be implemented using any known network protocol, including various wired or wireless protocols, such as, for example, Ethernet, Universal Serial Bus (USB), FIREWIRE, Global System for Mobile Communications (GSM), Enhanced Data GSM Environment (EDGE), code division multiple access (CDMA), time division multiple access (TDMA), Bluetooth, Wi-Fi, voice over Internet Protocol (VoIP), Wi-MAX, or any other suitable communication protocol.

External server(s) 60 may be implemented on one or more standalone data processing apparatus or a distributed network of computers. External server 60 may include a trained model 62 such as a large language model (LLM). The trained model may provide a text summary to head-mounted device 10 in response to information from head-mounted device 10.

Consider an example in which the user of head-mounted device 10 is reading a book while operating head-mounted device 10. A page of the book including text may be visible to the viewer through one or more see-through displays 32 in head-mounted device 10. The user may identify a paragraph in the book by pointing at the paragraph or using other forms of user input. In response, head-mounted device 10 may perform optical character recognition (OCR) to obtain machine-readable text for the paragraph. The head-mounted device 10 may provide the machine-readable text to trained model 62. The trained model 62 may summarize the paragraph and send the text summary to head-mounted device 10. The text summary may be presented by head-mounted device 10 (e.g., adjacent to the paragraph of text in the book). In this way, head-mounted device 10 may display text summaries of text in the user's physical environment using information from trained model 62.

The example of communicating with external server(s) 60 to obtain a text summary from trained model 62 is merely illustrative. If desired, head-mounted device 10 may summarize text using a trained model that is stored on the head-mounted device 10 (e.g., in memory of control circuitry 14).

Trained model 62 may be a large language model. A large language model (LLM) is an artificial intelligence system designed to understand and generate human language text. Large language models (LLMs) belong to the broader category of natural language processing (NLP) models and have the ability to process and generate text that is coherent, contextually relevant, and grammatically accurate. Large language models may be built using deep learning techniques (e.g., neural networks) which enable them to learn patterns and associations within vast amounts of textual data. LLMs are trained on datasets containing billions of words, which allows them to capture the nuances and complexities of human language. Large language models are characterized by their large scale (e.g., having a least one hundred million parameters, having at least one billion parameters, at least ten billion parameters, at least one hundred billion parameters, etc.).

Trained model 62 may therefore sometimes be referred to as artificial intelligence (AI) system 62, language model 62, large language model 62, natural language processing model 62, etc. Trained model 62 may be configured to output human language text in response to input. Trained model 62 may include at least one billion parameters, at least ten billion parameters, at least one hundred billion parameters, etc.

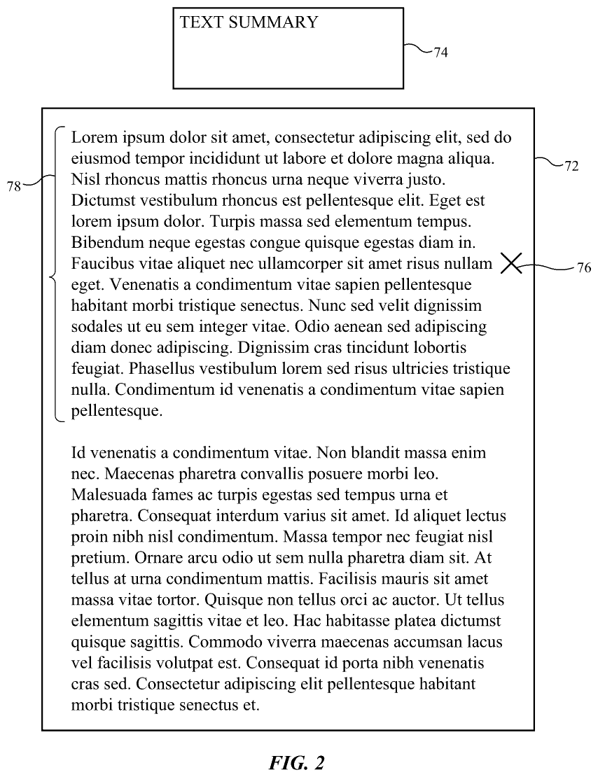

FIG. 2 is a view of a physical environment through one or more see-through displays 32. While the examples described below refer to the use of a see-through display, it should be appreciated that an opaque display implementing video passthrough can similarly be used. As shown in FIG. 2, the physical environment may include a physical object 72 that includes text. Physical object 72 may be a book, a newspaper, a magazine, a screen of a portable electronic device such as a cellular telephone or tablet computer, a screen of a computer monitor or television, etc. In the example of FIG. 2, physical object 72 includes two paragraphs of text. Sample text for the two paragraphs is included in FIG. 2 as an example, though it should be understood that the actual content of the text may vary.

It may be desirable to present a text summary that summarizes some or all of the text on physical object 72. Presenting the text summary may allow for the user of head-mounted device 10 to quickly absorb the information in the text. In the example of FIG. 2, text summary 74 is presented adjacent to physical object 72. With this arrangement, the text summary will not obscure the original text.

There are numerous ways to trigger the display of a text summary for some or all text that is viewable in a user's physical environment. The user may provide user input to one or more user input components to place the head-mounted device in an assisted reading mode. In one possible arrangement, the head-mounted device may automatically present text summaries for text in the user's physical environment while in the assisted reading mode. In other words, a text summary may be presented for text in the physical environment whenever the text is detected in images captured by camera(s) 36.

Alternatively, when the head-mounted device is in the assisted reading mode, the user may provide user input to trigger the presentation of a text summary. In addition to triggering the presentation of the text summary, the user input may select a particular subset of text in the physical environment to summarize (e.g., the user may select the first paragraph in FIG. 2).

The user input may include a button press. For example, the user may press a button on head-mounted device 10 to trigger a text summary to be displayed. The user may press the button again to trigger a text summary of a subsequent paragraph to be displayed. For example, the user may place the head-mounted device in the assisted reading mode. Subsequently, pressing the button a first time may cause a text summary of the first paragraph on physical object 72 to be displayed. Pressing the button a second time may cause a text summary of the second paragraph on physical object 72 to be displayed.

The user input may include a voice command. A microphone in head-mounted device 10 may be used to detect the voice command. The voice command may include commands such as “summarize,” “summarize the first paragraph,” summarize the next paragraph”, “next paragraph,” etc.

The user input may include a head gesture. The head gesture may include, as examples, an upward head tilt, a rightward head tilt, a nod, etc. The head gesture may trigger a text summary to be displayed. A head gesture may trigger a text summary of a subsequent paragraph to be displayed. For example, the user may place the head-mounted device in the assisted reading mode. Subsequently, an upward head tilt may cause a text summary of the first paragraph on physical object 72 to be displayed. A downward head tilt may cause a text summary of the paragraph below the currently summarized paragraph (e.g., the second paragraph on physical object 72) to be displayed. In examples where there are paragraphs side-by-side, a rightward head tilt may cause a text summary of the paragraph to the right of the currently summarized paragraph on physical object 72 to be displayed and a leftward head tilt may cause a text summary of the paragraph to the left of the currently summarized paragraph on physical object 72 to be displayed.

The user input may include a gaze gesture. The gaze gesture may include looking at a particular paragraph for longer than a threshold dwell time. For example, the user may place the head-mounted device in the assisted reading mode. Subsequently, the user may gaze at the first paragraph on physical object 72 for longer than the threshold dwell time, causing a text summary of the first paragraph to be displayed. Subsequently, the user may gaze at the second paragraph on physical object 72 for longer than the threshold dwell time, causing a text summary of the second paragraph to be displayed.

The user input may include a hand gesture such as a finger point. For example, the user may place the head-mounted device in the assisted reading mode. Subsequently, the user may point at the first paragraph on physical object 72 (e.g., at location 76 in FIG. 2), causing a text summary of the first paragraph to be displayed. Subsequently, the user may point at the second paragraph on physical object 72, causing a text summary of the second paragraph to be displayed.

In addition to selecting a subset of text using user input, the user may adjust the length of text being summarized using user input. In the aforementioned examples, one paragraph of text in the physical environment is summarized at a time. The user may adjust the size of the text being summarized from one paragraph of text to one page of text, two paragraphs of text, a given number of lines of text, etc.

A visual indicator may be presented on display 32 to identify which subset of text in the physical environment is being summarized. FIG. 2 shows an example where visual indicator 78 is a bracket that is aligned with the first paragraph which is summarized in text summary 74. This example is merely illustrative and visual indicator 78 may have any desired appearance that identifies a subset of text in the physical environment. For example, visual indicator 78 may include an arrow pointing to the subset of text, one or more lines around the perimeter of the subset of text, a box around the subset of text, a highlight (e.g., a yellow highlight) applied to the subset of text, etc. Visual indicator 78 may sometimes be referred to as arrow 78, bracket 78, reticle 78, etc.

The example above of head-mounted device 10 being switched into an assisted reading mode is merely illustrative. In some cases the head-mounted device 10 may be operable in a normal mode in addition to the assisted reading mode. Head-mounted device 10 may still present text summaries while in the normal mode. For example, an additional user input may be required to cause a text summary to be presented when the head-mounted display is in the normal mode. Requiring the additional user input in the normal mode may avoid false positives in which text summaries are presented when not desired by the user. In the assisted reading mode, the number of user inputs required to cause a text summary to be presented may be lower than in the normal mode and/or the type of user inputs required to cause a text summary to be presented may be different (e.g., easier) than in the normal mode.

Some head-mounted devices may not have a dedicated assisted reading mode. Head-mounted device 10 may still generate text summaries in response to one or more user inputs (even when the device does not have a dedicated assisted reading mode). In this type of embodiment, the number and type of user inputs required to cause a text summary to be presented may be the same during all operation of head-mounted device 10.

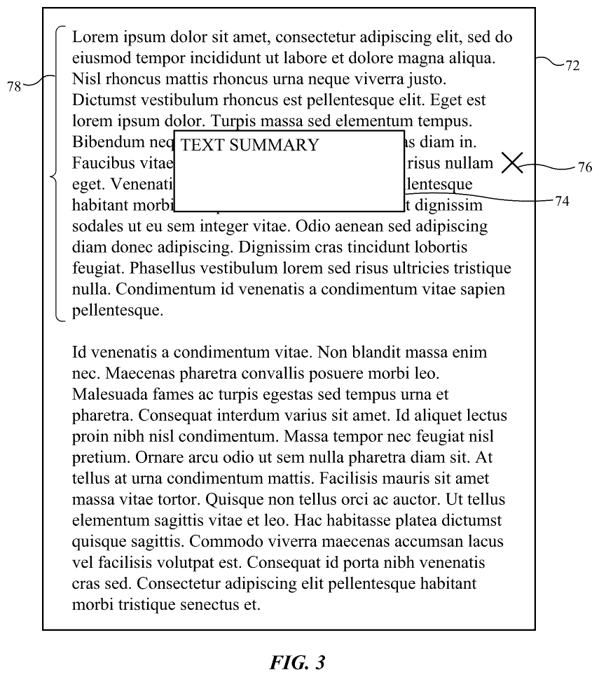

In the example of FIG. 2, text summary 74 is positioned on display(s) 32 such that the text summary does not overlap the text on physical object 72 when viewed through display(s) 32. This example is merely illustrative. In another possible arrangement, shown in FIG. 3, text summary 74 is positioned on display(s) 32 such that the text summary overlaps the text on physical object 72 when viewed through display(s) 32. In either of the arrangements of FIGS. 2 and 3, text summary 74 may be world-locked (e.g., world-locked to the text being summarized such that the text summary remains at a fixed position relative to the text being summarized from the perspective of the viewer), head-locked (e.g., head-locked in a center of the viewer's field of view), or body-locked.

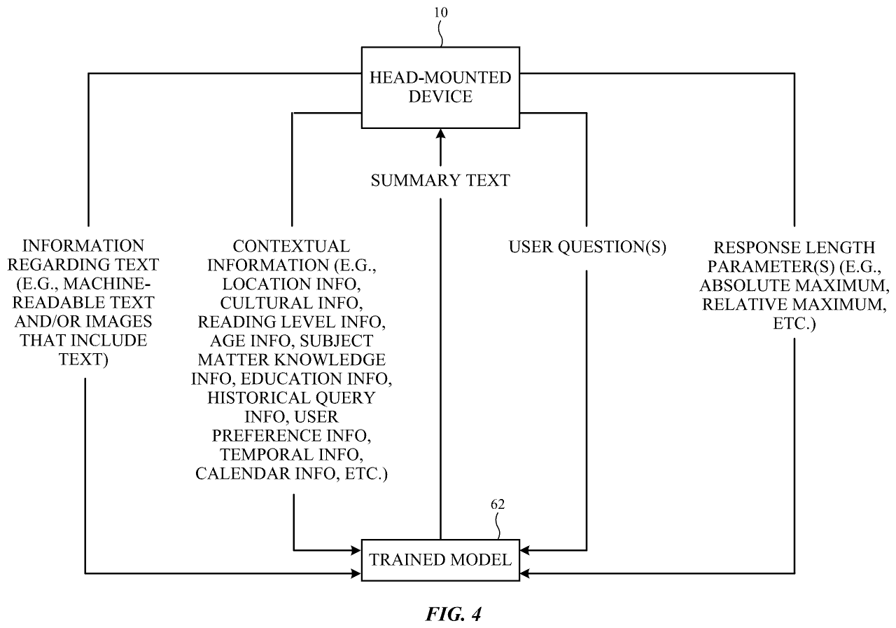

FIG. 4 is a schematic diagram of a head-mounted device that communicates with a trained model. In response to detecting a user intent to provide a summary of text in a physical environment, head-mounted device 10 may provide information to trained model 62. The trained model may return summary text to head-mounted device 10 based on the received information.

A wide range of information may be provided from head-mounted device 10 to trained model 62 in response to detecting a user intent to provide a summary of text. As shown in FIG. 4, head-mounted device 10 may provide information regarding the text to the trained model. The information regarding the text may include, as an example, a machine-readable version of the text being summarized. Instead or in addition, the information regarding the text may include one or more images that include the text being summarized.

As an example, in response to detecting a user intent to provide a summary of text, head-mounted device 10 may perform optical character recognition (OCR) on the text using images of the text captured using camera(s) 36. The OCR produces a machine-readable version of the text that is then provided to trained model 62.

As another example, in response to detecting a user intent to provide a summary of text, head-mounted device 10 may capture one or more images of the text using camera(s) 36. The one or more images may be provided directly to trained model 62. The trained model 62 may be capable of performing OCR on the text to obtain a machine-readable version of the text.

In addition to information regarding the text, head-mounted device 10 may provide contextual information to trained model 62. The contextual information may be used by trained model 62 to tailor the summary text. The contextual information may include information such as location information, cultural information, reading level information, age information, subject matter knowledge information, education information, historical query information, user preference information, temporal information, calendar information, etc.

The location information may include a city of residence of the user of head-mounted device 10, the current city in which head-mounted device 10 is located, etc. With all else being equal, the trained model 62 may provide a different text summary to a first user in a first location than a second user in a second location or may provide a different text summary to a first user with a first city of residence than a second user with a second, different city of residence. Current location information that is included in the location information provided to trained model 62 may be obtained using a global positioning system (GPS) sensor in head-mounted device 10, may be provided to head-mounted device 10 directly by the user, etc.

The cultural information may include a cultural background of the user of head-mounted device 10, cultural information associated with the current location of head-mounted device 10, etc. For example, for given text a user with a first cultural background may receive a first text summary that references a cultural custom associated with the first cultural background. A second user with a second cultural background that does not include the cultural custom may receive a second text summary for the given text that does not reference the cultural custom.

The reading level information may include an approximation of the reading level of the user of the head-mounted device. The complexity of the text summary output by trained model 62 may be adjusted based on the reading level of the user of the head-mounted device. For example, a first user with a fifth grade reading level may receive a first text summary for given text whereas a second user with an eighth grade reading level may receive a second text summary for the given text that is more complex than the first text summary.

The age information may include the age of the user of the head-mounted device. The complexity of the text summary output by trained model 62 may be adjusted based on the age of the user of the head-mounted device. For example, a first user of a first age may receive a first text summary for given text whereas a second user of a second age that is greater than the first age may receive a second text summary for the given text that is more complex than the first text summary.

The subject matter knowledge information may include details of particular subjects for which the user has a high or low knowledge base. Consider the example where the user of the head-mounted device 10 has an in-depth knowledge of biology and no prior exposure to computer science. This information may be identified in the subject matter knowledge information. In this example, text summaries output by trained model 62 related to biology may include more technical terms/details than if the user was not an expert in biology. Similarly, text summaries output by trained model 62 related to computer science may include less technical terms/details than if the user had prior exposure to computer science. A first user without expertise in a given subject matter may receive a first text summary for given text associated with the given subject matter whereas a second user with expertise in the given subject matter may receive a second text summary for the given text that is more complex than the first text summary.

The education information may include details of the user's educational history. Consider the example where the user of the head-mounted device 10 is a college graduate with a degree in biology. This information may be identified in the education information. In this example, text summaries output by trained model 62 related to biology may include more technical terms/details than if the user did not have a degree in biology.

The historical query information may include information regarding prior questions asked by the user and/or prior text that has been summarized by the user. For example, a user may request summaries of multiple paragraphs regarding a given historical event. Subsequently, the user may request a summary of a new paragraph. The trained model may receive historical query information identifying the previous summary requests associated with the given historical event. In view of this contextual information, the trained model may be more likely to reference the given historical event in a text summary of the new paragraph.

The user preference information may include any desired user preferences regarding the tone, length, and/or type of summary provided by trained model 62. The user preferences may be provided to head-mounted device 10 using one or more input components.

The temporal information may include information regarding the current time of day or the current time of year. With all else equal, the trained model may output a first text summary for given text at a first time of day and may output a second, different text summary for the given text at a second, different time of day. With all else equal, the trained model may output a first text summary for given text at a first time of year and may output a second, different text summary for the given text at a second, different time of year.

The calendar information may include information from the user's calendar such as upcoming appointments, travel, etc. For example, a user may be reading a guide book for a given location. If the calendar information identifies an upcoming vacation to the given location, the text summary output by the trained model may be different than if there was no upcoming vacation to the given location. For example, a user may be reading a textbook for a given subject. If the calendar information identifies an upcoming class for the given subject, the text summary output by the trained model may be different than if there was no upcoming class for the given subject.

It is noted that trained model 62 may infer additional contextual information based on the received pieces of contextual information. For example, the trained model 62 may infer reading level information and subject matter knowledge information based on received education information.

In addition to information regarding the text, head-mounted device 10 may provide one or more user questions to trained model 62. The user questions may include questions provided directly from the user to head-mounted device 10 using one or more input devices. For example, the user may ask questions that are detected using a microphone in head-mounted device 10. Instead or in addition, the user may provide a question using a keyboard (e.g., a physical keyboard associated with a computer, a touch-sensitive keyboard on a touch-sensitive display, a virtual keyboard, etc.). The question may address the paragraph being summarized. For example, the user might ask “what are the three most important points from this paragraph?” or “what argument is this paragraph making?” Trained model 62 may tailor the summary text based on the user question(s) received from head-mounted device 10.

In addition to information regarding the text, head-mounted device 10 may provide one or more response length parameters to trained model 62. The response length parameters may be used to control the length of the summary text provided by trained model 62. The response length parameters may include an absolute maximum, an absolute minimum, a relative maximum, and/or a relative minimum. The absolute maximum may be an absolute maximum word count for the text summary or an absolute maximum character count for the text summary. The relative maximum may be a relative maximum word count for the text summary or a relative maximum character count for the text summary. The absolute minimum may be an absolute minimum word count for the text summary or an absolute minimum character count for the text summary. The relative minimum may be a relative minimum word count for the text summary or a relative minimum character count for the text summary.

As one example, the response length parameters may include an absolute maximum of 100 words. In this case, the summary text output by trained model 62 may include a maximum of 100 words.

As another example, the response length parameters may include an absolute minimum of 25 words. In this case, the summary text output by trained model 62 may include a minimum of 25 words.

As another example, the response length parameters may include an absolute maximum of 500 characters. In this case, the summary text output by trained model 62 may include a maximum of 500 characters.

As another example, the response length parameters may include a relative maximum word count of 25%. In other words, the text summary may have a number of words that is no greater than 25% the number of words in the text being summarized. Consider an example where the text being summarized has 500 words. When the relative maximum word count is 25%, the summary text output by trained model 62 may include a maximum of 125 words. When the relative maximum word count is 10%, the summary text output by trained model 62 may include a maximum of 50 words.

As another example, the response length parameters may include a relative minimum word count of 5%. In other words, the text summary may have a number of words that is no less than 5% the number of words in the text being summarized. Consider an example where the text being summarized has 500 words. When the relative minimum word count is 5%, the summary text output by trained model 62 may include a minimum of 25 words. When the relative minimum word count is 10%, the summary text output by trained model 62 may include a minimum of 50 words.

As another example, the response length parameters may include a relative maximum character count of 25%. In other words, the text summary may have a number of characters that is no greater than 25% the number of characters in the text being summarized. Consider an example where the text being summarized has 2,500 characters. When the relative maximum character count is 20%, the summary text output by trained model 62 may include a maximum of 500 characters. When the relative maximum character count is 10%, the summary text output by trained model 62 may include a maximum of 250 characters.

Any of the aforementioned response length parameters may be inferred by the system and/or selected by the user. For example, contextual information may be used by control circuitry 14 to select or adjust one or more response length parameters. Instead or in addition, a user may provide user input to adjust one or more response length parameters.

In examples where multiple response length parameters are provided to trained model 62, the trained model may ensure that the summary text output to head-mounted device 10 is compliant with all of the response length parameters (e.g., adheres to an absolute maximum, a relative maximum, and an absolute minimum).

As one example, the response length parameters may be adjusted by the user using one or more user input devices. As one specific example, the user may adjust a slider to adjust the response length parameters. The slider may have one extreme at which the summary is capped at a small size (e.g., an absolute maximum of 50 words) and one extreme at which the summary is capped at a large size (e.g., an absolute maximum of 300 words). The slider may be adjusted between the two extremes to adjust the absolute maximum of the summary text.

It should be understood that the summary text output by trained model 62 is not a definition. Instead the summary text captures the main points, key ideas, and important details of the text being summarized. The summary text may usually be shorter than the text it is summarizing. However, if the response length parameter(s) allow, the summary text may sometimes be longer than the text being summarized. As an example, a short poem may be summarized using summary text that has more words and/or characters than the poem.

It should be understood that the summary text output by trained model 62 is not a translation. The summary text output by trained model 62 is the same language as the text being summarized. As examples, English text is summarized using English summary text, Spanish text is summarized using Spanish summary text, etc. If desired, a summary translation may be presented instead of summary text. As an example, Spanish text may be summarized using an English summary translation.

After receiving summary text from trained model 62, head-mounted device 10 may immediately present the summary text (e.g., as shown in FIGS. 2 and 3). Alternatively, head-mounted device may present a notification to the user after receiving the summary text from trained model 62. The notification may include a visual notification (presented using display 32), a haptic notification (presented using haptic output device 44), and/or an audio notification (presented using speaker 34). The user may optionally provide user input associated with the notification to cause the summary text to be presented on display 32.

As a specific example, the speaker may play a chime in response to receiving the summary text. Using spatial audio, the chime may have an associated location relative to the user. The head-mounted device may present the summary text in response to the user looking in the direction of the chime.

As another specific example, the speaker may display a visual indicator in the periphery of the user's field of view in response to receiving the summary text. The head-mounted device may present the summary text in response to the user looking in the direction of the visual indicator.

As another specific example, the haptic output device may provide haptic output in response to receiving the summary text. The head-mounted device may present the summary text in response to the user pressing a button after the haptic notification is presented.

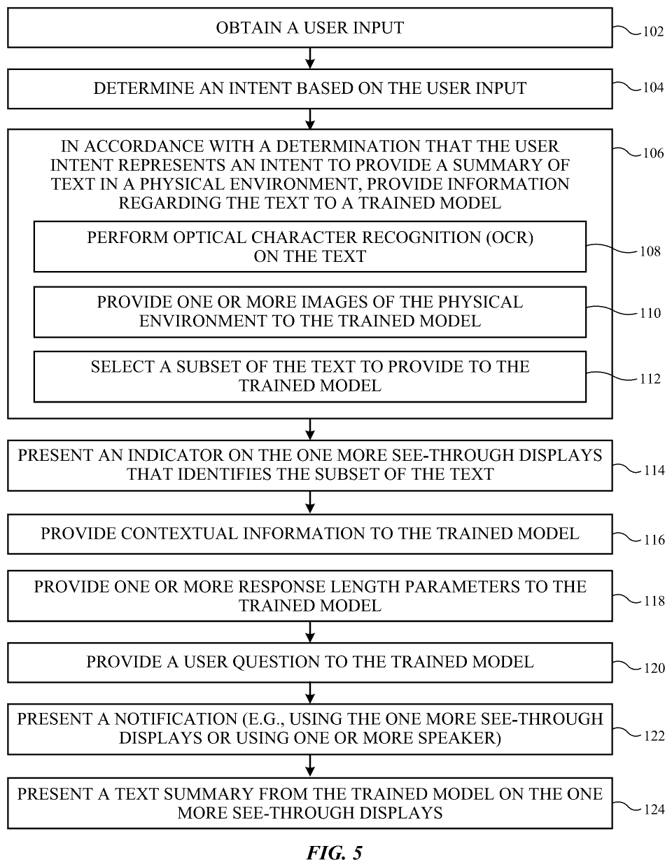

FIG. 5 is a flowchart showing an illustrative method for operating a head-mounted device that communicates with a trained model to summarize text. During the operations of block 102, the head-mounted device 10 (e.g., control circuitry 14) may obtain a user input. The user input may include a gaze gesture (e.g., dwelling on a subset of text for longer than a threshold dwell time) obtained using gaze tracking sensor 40, a head gesture (e.g., a nod or head movement) obtained using position and motion sensors 38, a voice command obtained using a microphone, a hand gesture (e.g., a finger point) obtained using one or more cameras 36, and/or a button press obtained using a button.

During the operations of block 104, head-mounted device 10 (e.g., control circuitry 14) may determine an intent based on the user input. The intent may be, for example, an intent to provide a summary of text in a physical environment.

During the operations of block 106, in accordance with a determination that the user intent represents an intent to provide a summary of text in a physical environment, head-mounted device 10 (e.g., control circuitry 14) may provide information regarding the text to a trained model. As previously discussed, the trained model may be a large language model (LLM) with at least one billion parameters.

Providing information regarding the text to the trained model may include, as shown by the operations of block 108, performing optical character recognition (OCR) on the text using one or more images captured by camera(s) 36. After performing the OCR on the text to generate machine-readable text at block 108, the machine-readable text may be provided to the trained model.

Providing information regarding the text to the trained model may include, as shown by the operations of block 110, providing one or more images captured by camera(s) 36 to the trained model. The trained model may use the one or more images for OCR operations to generate machine-readable text that is then used to generate a text summary.

The operations of block 106 may also include selecting a subset of the text in the physical environment to provide the trained model, as shown in the operations of block 112. The subset of text may be selected based on standing user preferences regarding the length of text to be summarized. For example, the user may have set a preference to summarize one paragraph of text, one page of text, two paragraphs of text, a given number of lines of text, etc.

The user may also provide user input to indicate which portion of the text is intended for the text summary. The user may indicate the desired subset of text using a gaze gesture (e.g., dwelling on a particular portion of the text), a head gesture, a voice command, a hand gesture (e.g., pointing a finger at a particular portion of the text), and/or a button press.

During the operations of block 114, the head-mounted device 10 (e.g., control circuitry 14) may present an indicator on the one or more displays 32 that identifies the subset of the text being summarized. An example of a visual indicator (e.g., a bracket) is shown in FIGS. 2 and 3. Other types of visual indicators may be used if desired.

During the operations of block 116, the head-mounted device 10 (e.g., control circuitry 14) may provide contextual information to the trained model. The contextual information may include information such as location information, cultural information, reading level information, age information, subject matter knowledge information, education information, historical query information, user preference information, temporal information, calendar information, etc.

During the operations of block 118, the head-mounted device 10 (e.g., control circuitry 14) may provide one or more response length parameters to the trained model. The response length parameters may be used to control the length of the summary text provided by trained model 62. The response length parameters may include an absolute maximum, a relative maximum, an absolute minimum, and/or a relative minimum. The response length parameters may be adjusted or selected based on contextual information such as location information, cultural information, reading level information, age information, subject matter knowledge information, education information, historical query information, user preference information, temporal information, calendar information, etc. Instead or in addition, the response length parameters may be adjusted at any time based on user input to one or more input components in head-mounted device 10. If the user adjusts the response length parameter(s) while a text summary is being presented, the text summary may be updated to reflect the new response length parameter(s).

During the operations of block 120, the head-mounted device 10 (e.g., control circuitry 14) may provide a user question to the trained model. The user question may be provided directly from the user to head-mounted device 10 using one or more input devices. For example, the user may ask questions that are detected using a microphone in head-mounted device 10. Instead or in addition, the user may provide a question using a keyboard (e.g., a physical keyboard associated with a computer, a touch-sensitive keyboard on a touch-sensitive display, a virtual keyboard, etc.).

During the operations of block 122, the head-mounted device 10 (e.g., control circuitry 14) may present a notification in accordance with receiving a text summary from the trained model. The notification may include a visual notification presented using display 32, an audio notification presented using speaker 36, and/or a haptic notification presented using haptic output device 44.

During the operations of block 124, the head-mounted device 10 (e.g., control circuitry 14) may present a text summary from the trained model on the one or more displays 32. The text summary may be world-locked, body-locked, or head-locked. The text summary may be shorter (e.g., in word count and/or character count) than the text being summarized. The text summary may be the same language as the text being summarized.

Presenting the text summary may include selecting a position for the text summary on the one or more displays 32 based on the one or more images of the physical environment captured by camera(s) 36. In possible arrangement (shown in FIG. 2), the position for the text summary does not overlap the text when the text is viewed through the one or more see-through displays. In another possible arrangement (shown in FIG. 3), the position for the text summary overlaps the text when the text is viewed through the one or more see-through displays.

Presenting the text summary during the operations of block 124 may include presenting the text summary after the notification is presented at block 122 and in response to additional user input confirming the user intent to present the text summary.

At block 124, instead of or in addition to presenting the text summary, the text summary may be audibly presented to the user by speaker 34. In other words, the text summary may be played aloud by speaker 34 in parallel with presenting the text summary on display 32 or instead of presenting the text summary on display 32.

It is noted that any or all of the operations of blocks 114, 116, 118, 120, 122, and 124 may be performed in accordance with a determination that the user intent represents an intent to provide a summary of text in a physical environment.

In general, the trained model may be stored in control circuitry 14 or stored in one or more external servers (e.g., external server(s) 60 from FIG. 1). When the trained model is stored in one or more external servers, the transfer of information to and from the trained model may be performed using communication circuitry 56 in head-mounted device. Communication circuitry 56 may wirelessly transmit the information regarding the text, the contextual information, the response length parameter(s), and/or the user question(s) to trained model 62. Communication circuitry 56 may wirelessly receive the text summary from the trained model.

Consider an example where a user is reading a book that is viewable through the see-through display(s) 32 of head-mounted device 10. During the operations of block 102, the user may point to a paragraph in the book with their finger. This gesture is detected using camera(s) 36 during the operations of block 102.

During the operations of block 104, control circuitry 14 may determine that the intent of the finger point is for the head-mounted device to provide a summary of the paragraph being pointed to.

During the operations of blocks 106, 108, and 112, in accordance with the determination that the user intent represents an intent to provide a summary of text in the physical environment, head-mounted device 10 may select a subset of the text in the physical environment (e.g., the paragraph being pointed to), perform optical character recognition on the subset of the text, and wirelessly provide a machine-readable version of the subset of the text to a trained model (e.g., a large language model).

During the operations of block 114, control circuitry 14 may present a visual indicator (e.g., a bracket or reticle) on display(s) 32 identifying the paragraph that is intended to be summarized.

During the operations of block 116, control circuitry 14 wirelessly provides contextual information to the trained model. In this example, the contextual information includes the user's current location (as determined using a GPS sensor in head-mounted device 10) and educational information for the user.

During the operations of block 118, control circuitry 14 wirelessly provides one or more response length parameters to the trained model. In this example, the response length parameters include an absolute minimum of 50 words and an absolute maximum of 150 words. These parameters ensure that the text summary received by the trained model will be between 50 words and 150 words.

During the operations of block 120, control circuitry 14 wirelessly provides a user question to the trained model. In this example, the user question (“what is the main argument of this paragraph?”) is provided audibly to a microphone in the head-mounted device and then communicated to the trained model by communication circuitry 56.

After the operations of blocks 116, 118, and 120, head-mounted device 10 may wirelessly receive a text summary from the trained model. The text summary may be based on the information regarding the text from block 106, the contextual information from block 116, the response length parameter from block 118, and the user question from block 120.

After receiving the text summary, head-mounted device 10 presents a visible notification during the operations of block 122. The visible notification identifies that the text summary is ready for viewing.

Finally, during the operations of block 124, the text summary from the trained model is presented on display(s) 32. In this example, the text summary is presented at a position that does not overlap the text in the physical environment (e.g., as in FIG. 2).

It is noted that, although the techniques described have been described in connection with text, the techniques may also be applicable to pictures, graphs, etc. For example, a user may point to a picture in their physical environment. The head-mounted device may send information regarding the picture (e.g., an image of the picture captured by camera 36) instead of information regarding text to a trained model and may receive a text summary of the picture from the trained model that is based on the information regarding the picture, contextual information, response length parameters, and/or user questions.

As another example, a user may point to a graph in their physical environment. The head-mounted device may send information regarding the graph (e.g., an image of the graph captured by camera 36) instead of information regarding text to a trained model and may receive a text summary of the graph from the trained model that is based on the information regarding the graph, contextual information, response length parameters, and/or user questions.

Additionally, the summary from the trained model may optionally include a graph or chart instead of or in addition to text. A user may point to text in their physical environment. The text may describe a trend. Instead of or in addition to a text summary, the head-mounted device may receive a graph from trained model 62 that summarizes the trend described in the text.

The techniques described above may also be used in a head-mounted device with an opaque display that presents a passthrough video feed of the user's physical environment.

The techniques described herein may be applicable to audio feedback in addition to visual text feedback. As an example, an electronic device such as a head-mounted device, cellular telephone, tablet computer, laptop computer, etc. may have a digital assistant that is capable of answering questions and/or requests (e.g., as detected using a microphone in head-mounted device 10) from the user. The digital assistant may provide audio feedback (e.g., using speaker 34) to the user that is determined using a trained model (similar to as in block 124 of FIG. 6) based on contextual information (as in block 116 of FIG. 6), response length parameters (as in block 118 of FIG. 6), and/or one or more user questions (as in block 120 of FIG. 6).

The example in FIG. 5 of generating a text summary using a trained model is merely illustrative. In another possible arrangement, head-mounted device 10 may generate the text summary by selecting some but not all of the selected subset of the text (without using the trained model). For example, the text summary may be generated using the first given number of sentences of the selected subset of the text, the first given number of words of the selected subset of the text, the first given number of sentences of each paragraph in the selected subset of the text, the first given number of words of each paragraph in the selected subset of the text, etc. The given number may be equal to 1, 2, 3, 4, 5, more than 5, more than 10, etc. The example of selecting the first given number of words/sentences is merely illustrative and any desired words/sentences from the text may be selected by head-mounted device 10 to generate the text summary (e.g., the last two sentences in each paragraph, the middle two sentences in each paragraph, etc.).

As described above, one aspect of the present technology is the gathering and use of information such as sensor information. The present disclosure contemplates that in some instances, data may be gathered that includes personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, username, password, biometric information, or any other identifying or personal information.

The present disclosure recognizes that the use of such personal information, in the present technology, can be used to the benefit of users. For example, the personal information data can be used to deliver targeted content that is of greater interest to the user. Accordingly, use of such personal information data enables users to have control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the United States, collection of or access to certain health data may be governed by federal and/or state laws, such as the Health Insurance Portability and Accountability Act (HIPAA), whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to provide certain types of user data. In yet another example, users can select to limit the length of time user-specific data is maintained. In addition to providing “opt in” and “opt out” options, the present disclosure contemplates providing notifications relating to the access or use of personal information. For instance, a user may be notified upon downloading an application (“app”) that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of information that may include personal information data to implement one or more various disclosed embodiments, the present disclosure also contemplates that the various embodiments can also be implemented without the need for accessing personal information data. That is, the various embodiments of the present technology are not rendered inoperable due to the lack of all or a portion of such personal information data.

The foregoing is merely illustrative and various modifications can be made to the described embodiments. The foregoing embodiments may be implemented individually or in any combination.

What is claimed is:

1. An electronic device comprising:
one or more cameras;
one or more displays;
one or more processors; and
memory storing instructions configured to be executed by the one or more processors, the instructions for:
obtaining a user input;
determining an intent based on the user input; and
in accordance with a determination that the user intent represents an intent to provide a summary of text in a physical environment:
obtaining a text summary based on information regarding the text, the information regarding the text obtained from one or more images of the physical environment captured using the one or more cameras; and
presenting the text summary on the one more displays.

2. The electronic device defined in claim 1, wherein obtaining the text summary based on the information regarding the text comprises providing the information regarding the text to a trained model.

3. The electronic device defined in claim 2, wherein providing the information regarding the text to the trained model comprises:
performing optical character recognition (OCR) on the text, wherein performing optical character recognition on the text comprises converting the text into machine-readable text; and
providing the machine-readable text to the trained model.

4. The electronic device defined in claim 3, further comprising:
communication circuitry, wherein providing the machine-readable text to the trained model comprises providing the machine-readable text to the trained model using the communication circuitry.

5. The electronic device defined in claim 2, wherein providing the information regarding the text to the trained model comprises providing the one or more images to the trained model.

6. The electronic device defined in claim 2, wherein the instructions further comprise instructions for:
providing contextual information to the trained model in addition to the information regarding the text, wherein the text summary is based on both the contextual information and the information regarding the text and wherein the contextual information comprises location information, cultural information, reading level information, age information, subject matter knowledge information, education information, historical query information, user preference information, temporal information, or calendar information.

7. The electronic device defined in claim 2, wherein the instructions further comprise instructions for:
providing one or more response length parameters to the trained model in addition to the information regarding the text, wherein the text summary is based on both the one or more response length parameters and the information regarding the text and wherein the one or more response length parameters comprises an absolute maximum for a length of the text summary, a relative maximum that is based on a length of the text, an absolute minimum for a length of the text summary, or a relative minimum that is based on a length of the text.

8. The electronic device defined in claim 2, wherein providing information regarding the text to the trained model comprises providing information regarding only a subset of the text to the trained model, wherein the electronic device further comprises one or more input components, and wherein the instructions further comprise instructions for:
selecting the subset of the text based on input to the one or more input components, wherein the one or more input components comprises a gaze detection sensor, a microphone, or a button; and
presenting an indicator on the one more displays that identifies the subset of the text.

9. The electronic device defined in claim 1, wherein the instructions further comprise instructions for:
selecting a position for the text summary on the one more displays based on the one or more images of the physical environment, wherein presenting the text summary on the one more displays comprises presenting the text summary on the one more displays at the selected position.

10. A non-transitory computer-readable storage medium storing one or more programs configured to be executed by one or more processors of an electronic device that comprises one or more cameras and one or more displays, wherein the one or more programs include instructions for:
obtaining a user input;
determining an intent based on the user input; and
in accordance with a determination that the user intent represents an intent to provide a summary of text in a physical environment:
obtaining a text summary based on information regarding the text, the information regarding the text obtained from one or more images of the physical environment captured using the one or more cameras; and
presenting the text summary on the one more displays.

11. The non-transitory computer-readable storage medium defined in claim 10, wherein obtaining the text summary based on the information regarding the text comprises providing the information regarding the text to a trained model.

12. The non-transitory computer-readable storage medium defined in claim 11, wherein providing the information regarding the text to the trained model comprises:
performing optical character recognition (OCR) on the text, wherein performing optical character recognition on the text comprises converting the text into machine-readable text; and
providing the machine-readable text to the trained model.

13. The non-transitory computer-readable storage medium defined in claim 12, wherein the electronic device further comprises communication circuitry and wherein providing the machine-readable text to the trained model comprises providing the machine-readable text to the trained model using the communication circuitry.

14. The non-transitory computer-readable storage medium defined in claim 11, wherein providing the information regarding the text to the trained model comprises providing the one or more images to the trained model.

15. The non-transitory computer-readable storage medium defined in claim 11, wherein the instructions further comprise instructions for:
providing contextual information to the trained model in addition to the information regarding the text, wherein the text summary is based on both the contextual information and the information regarding the text and wherein the contextual information comprises location information, cultural information, reading level information, age information, subject matter knowledge information, education information, historical query information, user preference information, temporal information, or calendar information.

16. The non-transitory computer-readable storage medium defined in claim 11, wherein the instructions further comprise instructions for:
providing one or more response length parameters to the trained model in addition to the information regarding the text, wherein the text summary is based on both the one or more response length parameters and the information regarding the text and wherein the one or more response length parameters comprises an absolute maximum for a length of the text summary, a relative maximum that is based on a length of the text, an absolute minimum for a length of the text summary, or a relative minimum that is based on a length of the text.

17. The non-transitory computer-readable storage medium defined in claim 11, wherein providing information regarding the text to the trained model comprises providing information regarding only a subset of the text to the trained model, wherein the electronic device further comprises one or more input components, and wherein the instructions further comprise instructions for:
selecting the subset of the text based on input to the one or more input components, wherein the one or more input components comprises a gaze detection sensor, a microphone, or a button; and
presenting an indicator on the one more displays that identifies the subset of the text.

18. The non-transitory computer-readable storage medium defined in claim 10, wherein the instructions further comprise instructions for:
selecting a position for the text summary on the one more displays based on the one or more images of the physical environment, wherein presenting the text summary on the one more displays comprises presenting the text summary on the one more displays at the selected position.

19. A method of operating an electronic device that comprises one or more cameras and one or more displays, the method comprising:
obtaining a user input;
determining an intent based on the user input; and
in accordance with a determination that the user intent represents an intent to provide a summary of text in a physical environment:
obtaining a text summary based on information regarding the text, the information regarding the text obtained from one or more images of the physical environment captured using the one or more cameras; and
presenting the text summary on the one more displays.

20. The method defined in claim 19, wherein obtaining the text summary based on the information regarding the text comprises providing the information regarding the text to a trained model.

21. The method defined in claim 20, wherein providing the information regarding the text to the trained model comprises:
performing optical character recognition (OCR) on the text, wherein performing optical character recognition on the text comprises converting the text into machine-readable text; and
providing the machine-readable text to the trained model.

22. The method defined in claim 21, wherein the electronic device further comprises communication circuitry and wherein providing the machine-readable text to the trained model comprises providing the machine-readable text to the trained model using the communication circuitry.

23. The method defined in claim 20, wherein providing the information regarding the text to the trained model comprises providing the one or more images to the trained model.

24. The method defined in claim 20, further comprising:
providing contextual information to the trained model in addition to the information regarding the text, wherein the text summary is based on both the contextual information and the information regarding the text and wherein the contextual information comprises location information, cultural information, reading level information, age information, subject matter knowledge information, education information, historical query information, user preference information, temporal information, or calendar information.

25. The method defined in claim 20, further comprising:
providing one or more response length parameters to the trained model in addition to the information regarding the text, wherein the text summary is based on both the one or more response length parameters and the information regarding the text and wherein the one or more response length parameters comprises an absolute maximum for a length of the text summary, a relative maximum that is based on a length of the text, an absolute minimum for a length of the text summary, or a relative minimum that is based on a length of the text.

26. The method defined in claim 20, wherein providing information regarding the text to the trained model comprises providing information regarding only a subset of the text to the trained model, wherein the electronic device further comprises one or more input components, and wherein the method further comprises:
selecting the subset of the text based on input to the one or more input components, wherein the one or more input components comprises a gaze detection sensor, a microphone, or a button; and
presenting an indicator on the one more displays that identifies the subset of the text.

27. The method defined in claim 19, further comprising:
selecting a position for the text summary on the one more displays based on the one or more images of the physical environment, wherein presenting the text summary on the one more displays comprises presenting the text summary on the one more displays at the selected position.
